(19) United States
(12) Patent Application Publication
(10) Pub. No.: US 2017/0040604 A1
(43) Pub. Date: Feb. 9, 2017

(54) LITHIUM METAL FREE SILICON / SULFUR ACCUMULATOR

(71) Applicant: INSTITUTE OF BATTERIES, LLC, Astana (KZ)

(72) Inventors: Zhumabay Bakenov, Astana (KZ); Toru Hara, Astana (KZ); Indira Kurmanbayeva, Koschy (KZ); Almagul Mentbayeva, Astana (KZ); Aishuak Konarov, Koschy (KZ)

(73) Assignee: INSTITUTE OF BATTERIES, LLC, Astana (KZ)

(21) Appl. No.: 14/940,744

(22) Filed: Nov. 13, 2015

(30) Foreign Application Priority Data
Aug. 3, 2015 (KZ) 2015/0919.1

(51) Int. Cl. H01M 4/38; H01M 4/58; H01M 10/052; H01M 4/62

(52) U.S. Cl. CPC H01M 4/386; H01M 4/624; H01M 4/623; H01M 4/625; H01M 4/5815; H01M 10/052

(57) ABSTRACT

A rechargeable battery includes a stack made up of an anode, a separator wetted in an organic electrolyte, and a cathode. The stack is free of metal lithium. In these conditions, the anode is pre-lithiated and comprises silicon, and the cathode includes sulfur. A method of assembling this rechargeable battery is also provided.

The invention relates to rechargeable batteries (accumulators), in particular, to the rechargeable batteries comprising a sulfur-based cathode.

Known batteries include a stack comprising a positive electrode (i.e. a cathode), a negative electrode (i.e. an anode) and a delimiter (i.e. a separator) isolating electrically the cathode from the anode. In these conditions, the said stack is immersed in an electrolyte having an electrochemical communication with the cathode and the anode or the separator is wetted by the electrolyte in view to provide the electrochemical communication between the cathode and to the anode.

Lithium-sulfur (in abbreviated form Li/S) batteries are considered as ones of the most promising candidates for a next generation of the rechargeable accumulators. This is due to very high theoretical capacities of metallic lithium and elemental sulfur: 3850 mAh/g and 1672 mAh/g respectively compared with conventional electrode materials such as:

graphite which is used in the known batteries as an anode material and has a theoretical capacity 372 mAh/g, and
oxide of lithium and another metal (for example, LiCoO₂) which is used in the known batteries as a cathode material and has a theoretical capacity 274 mAh/g, but in practice it is around 140 mAh/g.
However, the lithium-sulfur batteries have critical drawbacks that would be removed:
lithium dendrite growth due to use of lithium metal anode, which may cause an internal short circuit failure,
electrically insulating nature of sulfur (used on the cathode) that requires a large amount of conducting agents (additives), which are electrochemically inactive (i.e. do not contribute in energy storage), thus reducing capacity of the lithium-sulfur battery due to lower sulfur mass-loading,
dissolution of polysulfides, formed upon electrochemical reaction, into the electrolyte and their consequent transfer towards the anode causing capacity fading.

In regards of the cathode, it is known that the intrinsic insulating nature of sulfur may be compensated by mixing sulfur with conducting agents such as conducting carbon materials. Recently, it was suggested:

an infiltration of sulfur into meso- and/or micro-porous carbon materials [L. Yuan, H. Yuan, X. Qiu, L. Chen, and W. Zhu, J. Power sources, 189, 1141 (2009)],
in-situ polymerization of conducting polymers in sulfur-dispersed solution [J: Wang, J. Chen, K. Konstantinov, L. Zhao, S. H. Ng, G. X. Wang, Z. P. Guo, and H. K. Liu, Electrochimica Acta, 51, 4634 (2006)],
a combination of conducting polymers and nano-structured carbon materials [F. Wu, J. Chen, L. Li, T. Zhao, and R. Chen, J. Phys. Chem. C 115, 24411 (2011)].

Although an effectiveness of sulfur use, namely, an available gravimetric capacity of composites, has been improved by these methods, a more serious problem is a sulfur mass-loading per unit area of less than 2 mg/cm² offering a capacity per unit area of less than 2 mAh/g. This limited mass-loading of sulfur means that this cathode cannot offer a capacity higher than that of conventional LiCoO₂-based cathodes with at least 2.5 mAh/g.

It is known that the capacity fading of the sulfur-based cathode resulting from the dissolution of polysulfides can be also restricted/suppressed by forming sulfur/polyacrylonitrile composites (in abbreviated form S/PAN) by heat-treatment of a sulfur/polyacrylonitrile mixture [J. Wang, J. Yang, J. Xie, and N. Xu, Adv. Mater., 14, 963 (2002)]. Partially pyrolyzed and cyclized polyacrylonitrile can stabilize and suppress the sulfur dissolution into an electrolyte solution through a redistribution of electrons in outermost electronic orbitals or through forming chemical bonds between polyacrylonitrile and sulfur through polarized C—N chemical bonds.

Silicon (in abbreviated form Si) has a theoretical capacity of 4200 mAh/g (practically its value is equal to 1000-2000 mAh/g). Therefore, silicon can be used as an alternative to metal lithium (in abbreviated form Li) in the anodes, for example, in the batteries in which the cathode material comprises oxides of lithium and another metal such as LiCoO₂. There are known works on this anode comprising silicon: see, for example:

### [H. Wu, G. Zheng, N. Liu, T. J. Carney, Y. Yang, and Y. Cui, Nano Le 12, 904-909 (2012)],

[J. Luo, X. Zhao, J. Wu, H. D. Sang, H. H. Kung, and J. Huang, Phys. Chem. Lett., 3, 1824-1829 (2012)], and
[D. M. Piper, T. A. Yersak, S.-B. Son, S. C. Kim, C. S. Kang, K. H. Oh, C. Ban, A. C. Dillon, and S.-H. Lee, Adv. Energy Mater., 3, 697 (2013)].

However, the sulfur mass-loading (into the cathodes) into the published works is too low (from 0.1 to 1 mg/cm²) and is not sufficient for obtaining a high capacity and energy density. Furthermore, when the sulfur mass-loading is increased, the cathode is peeled-off from a current collector. This limited sulfur mass-loading means that this cathode comprising sulfur cannot offer a capacity higher than that of conventional LiCoO₂-based cathodes with at least 2.5 mAh/g.

Based on the original observations described above, the present invention mainly has as a goal to propose a rechargeable battery (accumulator) which comprises a stack consisting of an anode, a separator wetted in an organic electrolyte, and a cathode, and which is deprived of at least some of the above-mentioned disadvantages. In addition, the present invention has as a goal to propose a method of assembling of such rechargeable battery.

According to one of its embodiments, the invention concerns a rechargeable battery comprising a stack consisting of an anode, a separator wetted in an organic electrolyte, and a cathode. According to the invention, the stack is free of metal lithium. In these conditions, the anode is pre-lithiated and comprises silicon (for example, a composite anode such as silicon/polyacrylonitrile (in abbreviated form Si/PAN)) and the cathode comprises sulfur (for example, a composite cathode such as sulfur/polyacrylonitrile (in abbreviated form S/PAN).

Due to these advantageous features, the rechargeable battery has no disadvantages described above which are typical for the Li/S batteries or for the Si/LiCoO₂ batteries.

Preferably, the anode consists of a pre-lithiated heat-treated first composite. This first composite comprises a conductive porous substrate cast by a first slurry. This first slurry is a first mixture comprising a silicon powder, a conductive polymer and dimethylformamide.

This advantageous feature contributes to a growth of silicon mass-loading into the anode simultaneously with increasing of its (anode) electrical conductivity and a reliable fixation of silicon on the anode.

Preferably, the cathode consists of a heat-treated second composite. This second composite comprises the conductive porous substrate cast by a second slurry. This second slurry is a second mixture comprising a sulfur-based third composite, a carbon-based conductive agent and a binder.

This advantageous feature contributes to a growth of sulfur mass-loading into the cathode simultaneously with increasing of its (cathode) electrical conductivity and a reliable fixation of sulfur on the cathode.

Preferably, the conductive polymer is selected from a following group of polymers: (i) polyacrylonitrile ; (ii) polypyrrole.

Said conductive polymers are readily available and, thus, adapted for mass production of the rechargeable batteries according to the invention.

Preferably, the sulfur-based third composite consists of a heat-treated third mixture selected from a following group of mixtures:

(a) a mixture of a sulfur powder with the conductive polymer,

(b) a mixture of a sulfur powder with a carbon material selected from a following group of materials:
(i) granulated electroconductive carbon black_{;}
(j) acetylene black.

Said materials are readily available and, thus, adapted for mass production of the rechargeable batteries according to the invention.

Preferably, the conductive porous substrate is selected from a group of following materials: (a) carbon fiber paper; (b) carbon cloth.

Said materials are readily available and, thus, adapted for mass to production of the rechargeable batteries according to the invention.

Preferably, the carbon-based conductive agent consists of acetylene black.

Said conductive agent is readily available and, thus, adapted for mass production of the rechargeable batteries according to the invention,

Preferably, the binder consists of polyvinylidene fluoride in n-methyl-2-pyrrolidinone with a weight ratio polyvinylidene fluoride/n-methyl-2-pyrrolidinone being equal 1/1.2.

Said binder is readily available and, thus, adapted for mass production of the rechargeable batteries according to the invention.

Preferably, a silicon mass-loading into the pre-lithiated anode is 2.5 mg/cm², and a sulfur mass-loading into the cathode is 4 mg/cm².

Due to these advantageous features, the lithium metal free silicon/sulfur battery according to the invention shows a capacity at least comparable to known rechargeable batteries.

Preferably, the silicon powder comprises particles having a diameter from 30 nm to 50 nm.

The specified particles size of the silicon powder contributes to its optimal fixation on external and internal surfaces of the conductive porous substrate.

Preferably, the silicon powder is free from a surface film consisting of silicon oxide.

This feature contributes to increasing the electrical conductivity of the anode and a reliable fixation of silicon on the anode.

Preferably, the sulfur powder comprises particles having a 100 mesh diameter.

The specified particles size of the sulfur powder contributes to its optimal fixation on the external and internal surfaces of the conductive porous substrate.

Preferably, the organic electrolyte consists of a solution of 1 mol*dm⁻³ lithium hexafluorophosphate salt in a fourth mixture. This fourth mixture consists of ethylene carbonate, ethylmethyl carbonate and dimethyl carbonate with a volume ratio 1/1/1.

This feature contributes to increasing the electrical conductivity of the separator.

Preferably, the first composite comprises the conductive porous substrate consisting of the carbon fiber paper having a first thickness equal to 110 μm, and the second composite comprises the conductive porous substrate consisting of the carbon fiber paper having a second thickness equal to 370 μm.

This feature contributes to optimizing a thickness of the stack consisting of the anode, the separator wetted in the organic electrolyte, and the cathode, so that it could be easily put into a button cell or into a housing of a prismatic battery.

According to a second of its embodiments, the invention concerns a method of assembling of a rechargeable battery, the method comprising:

a first phase of manufacturing of an anode from a first composite,
a second phase of manufacturing of a cathode from a second composite,
a third phase of manufacturing of a stack consisting of the anode, a separator wetted in an organic electrolyte, and the cathode, and of putting this stack into a housing of the rechargeable battery.
According to the invention, the first phase of manufacturing of the anode from the first composite includes:
a stage of first slurry preparing by mixing a silicon powder, a conductive polymer and dimethylformamide,
a stage of first slurry casting into a porous conductive substrate for obtaining a first composite,
a stage of heat-treatment of the first composite into an inert atmosphere for obtaining a silicon-based anode,
a stage of short-circuiting of the silicon-based anode with metal lithium in an organic electrolyte for obtaining the pre-lithiated silicon-based anode.

Preferably, the first phase of manufacturing of the anode from the first composite also includes a stage of removing of a surface film consisting of silicon oxide from particles of the silicon powder.

Preferably, the second phase of manufacturing of a cathode from a second composite includes:

a stage of preparing of a sulfur-based third composite,
a stage of second slurry preparing by mixing the sulfur-based third composite, a carbon-based conductive agent and a binder,
a stage of second slurry casting into the porous conductive substrate for obtaining a second composite,
a stage of heat-treatment of the second composite for obtaining the sulfur-based cathode.

Preferably, the conductive porous substrate is selected from a group of following materials: (a) carbon fiber paper; (b) carbon cloth.

In a first completion variant of the method of assembling according to the invention, the stage of preparing of the sulfur-based third composite includes a stage of mixing of a sulfur powder with the conductive polymer. In these conditions, the conductive polymer is selected from a following group of polymers: (a) polyacrylonitrile ; (b) polypyrrole.

In a second completion variant of the method of assembling according to the invention, which is alternative to the first variant, the stage of preparing to of the sulfur-based third composite includes a stage of mixing of a sulfur powder with a carbon material. In these conditions, the carbon material is selected from a following group of the carbon materials: (a) granulated electroconductive carbon black, (b) acetylene black.

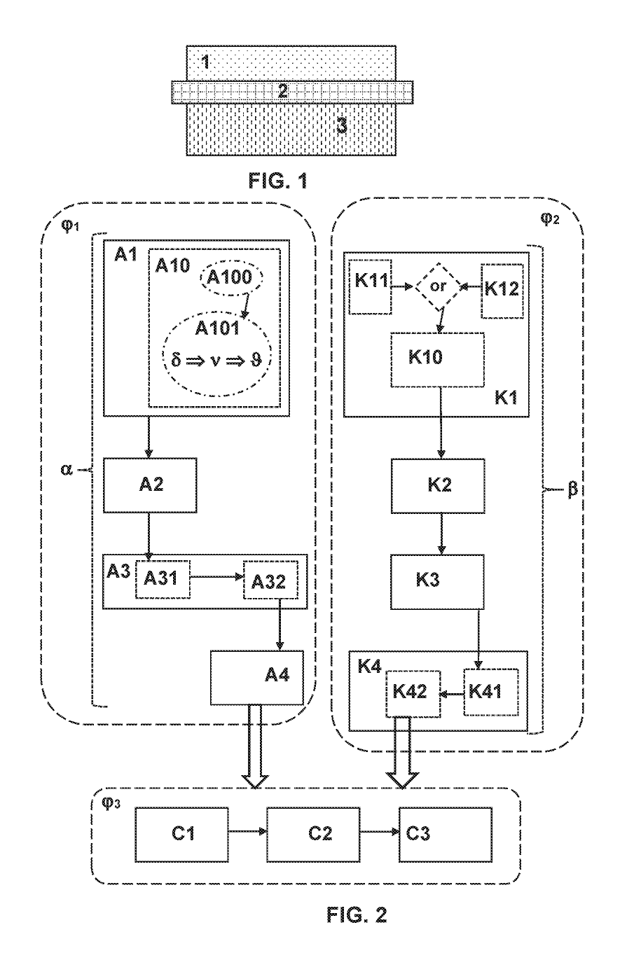

Other distinguishing features and advantages of the invention ensue from the description given below to illustrate the essence of the invention. This description is not restrictive for the invention. In addition, the description comprises references to accompanying FIGS. 1 and 2. These FIGS. 1 and 2 are included into the description, i.e. they are its integral part.

FIG. 1 shows a stack “anode/separator/cathode” (i.e. a rechargeable element) for a lithium metal free silicon/sulfur accumulator according to the invention. As can be seen from the FIG. 1, the said stack comprises three following parts:

a first part which illustrates schematically a pre-lithiated silicon-based anode 1,
a second part which illustrates schematically a separator 2, and
a third part which illustrates schematically a sulfur-based cathode 3.

FIG. 2 shows an assembling flowchart of the lithium metal free silicon/sulfur accumulator according to the invention.

The first part of the stack of the lithium metal free silicon/sulfur accumulator according to the invention in FIG. 1 namely, the pre-lithiated silicon-based anode 1, may comprise:

a porous (electrical current) conductive substrate, for example, a carbon fiber paper (in abbreviated form OFF) having a thickness of 110 μm, and
a silicon powder, a silicon mass-loading into the electrode being equal to 2.5 mg/cm². In these conditions, cyclized polyacrylonitrile (in abbreviated form PAN) formed upon heat treatment, homogeneously covers the silicon powder and the carbon fiber paper.

A first method of manufacturing α (from a first composite) of the pre-lithiated silicon-based anode 1 for the lithium metal free silicon/sulfur accumulator according to the invention comprises four stages A1, A2, A3 and A4 described below (FIG. 2).

During the stage A1, it is prepared a first slurry, which comprises a first mixture comprising a silicon powder, a conductive polymer and dimethylformamide (in abbreviated form DMF).

During the stage A2, this first slurry (resulting from the stage A1) is cast into a porous conductive substrate. Preferably, this porous conductive substrate is a macroporous material having a pore size more than 75 microns and a porosity of about 85% (for example, from 80% to 90%). Preferably, a thickness of the porous conductive substrate consists of less than 250 microns (for example, from 100 microns to 250 microns). These selective physical parameters of the porous conductive substrate provide a more optimal coverage by the first slurry of external and internal surfaces of the porous conductive substrate during a process of first slurry casting A2 into the porous conductive substrate. The carbon fiber paper may be used as the porous conductive substrate. As an alternative of the carbon fiber paper, a carbon cloth may also be used as the porous conductive substrate. As a result of this casting A2, the first slurry covers the external surface of the porous conductive substrate, as well as the internal surface of the porous conductive substrate (thus, as a result of this casting A2, the first slurry penetrates into the pores of the porous conductive substrate). This contributes to a growth of silicon mass-loading into the anode according to the invention.

During the stage A3, the porous conductive substrate (for example, the above-mentioned carbon fiber paper) cast by the first slurry as a result of the stage A2, is exposed to a heat-treatment into an inert atmosphere (for example, at 300° C. in an argon atmosphere). This heat-treatment permits to fix particles of the silicon powder (which are in the first slurry) on the external and internal surfaces of the conductive porous substrate. Thus, the conductive to porous substrate with silicon particles fixed on it, forms a stable three-dimensional current collecting network. In these conditions, polyacrylonitrile, which is formed during the heat-treatment, homogeneously covers the said three-dimensional current collecting network. As a result of the heat-treatment, polyacrylonitrile becomes partially pyrolyzed and cyclized and encapsulates (i.e. envelops) the silicon particles. This contributes to increase an electrical conductivity of the anode according to the invention.

During the stage A4, a short-circuit of the silicon-based anode resulting from the stage A3 with metal lithium is carried out. This short-circuit is realized by a direct contact of the silicon-based anode resulting from the stage A3 with metal lithium in an organic electrolyte. A solution of 1 mol*dm⁻³ lithium hexafluorophosphate salt (in abbreviated form LiFF₆) in a mixture of ethylene carbonate/ethylmethyl carbonate/dimethyl carbonate (with a volume ratio 1/1/1) can serve as example of such organic electrolyte. Thus, the pre-lithiated silicon-based anode 1 adapted for using in the lithium metal free silicon/sulfur accumulator according to the invention is obtained as a result of the stage A4. The pre-lithiation is required for an expected operation of the rechargeable battery according to the invention because the silicon-based anode as well as the sulfur-based cathode (FIG. 1) do not comprise lithium ions.

The second part of the stack according to the invention in FIG. 1, namely, the separator 2, may be represented by a polyethylene- or polypropylene-based membrane.

The third part of the stack according to the invention in FIG. 1, namely, the sulfur-based cathode 3 may comprise the conductive porous substrate, for example, the carbon fiber paper having a thickness of 110 μm, and sulfur with mass-loading of 4 mg/cm². In these conditions, sulfur is homogeneously distributed in cyclized polyacrylonitrile or in a carbon material.

A second method of manufacturing β (from a second composite) of the sulfur-based cathode 3 for the lithium metal free silicon/sulfur accumulator according to the invention comprises four stages K1, K2, K3 and K4 described below (FIG. 2).

During the stage K1, it is prepared a sulfur-based third composite.

In a first variant of the stage K1, sulfur is mixed K11 with the conductive polymer, for example, with polyacrylonitrile or with polypyrrole (in abbreviated form PPy) in view to obtain a composite mixture “sulfur/conductive polymer” (for example, S/PAN or S/PPy). Further, the obtained composite mixture “sulfur/conductive polymer” is exposed to a heat-treatment K10 into an inert atmosphere, for example, at 300° C. in an argon atmosphere during three hours. The sulfur-based third composite (more precisely, a first variant of the third composite) of “sulfur/conductive polymer” type is prepared.

In a second variant of the stage K1 (alternative of the first variant of the stage K1 described above), sulfur is mixed K12 with a carbon material selected, for example, from following materials: (a) granulated electroconductive carbon black (for example, produced by Akzo Nobel company under the name of Ketjenblack 3), in abbreviated form KB), (b) acetylene black (in abbreviated form AB), in view to obtain a composite mixture “sulfur/carbon material” (for example, S/KB or S/AB), Further (by analogy with the first variant described above), the composite mixture “sulfur/carbon material” is exposed to a heat-treatment K10 into the inert atmosphere, for example, at 300° C. in the argon atmosphere during three hours. The sulfur-based third composite (more precisely, the second variant of the third composite) of “sulfur/carbon material” type is prepared.

During the stage K2, it is prepared a second slurry comprising:

the sulfur-based third composite resulting from the stage K1: for example, the first variant of the “sulfur/conductive polymer” third composite (S/PAN or S/PPy) or—alternatively—the second variant of the “sulfur/carbon material” third composite (S/KB or S/AB),
a carbon-based (electrical current) conductive agent, for example: acetylene black (in abbreviated form AB), and
a binder, for example, polyvinylidene fluoride (in abbreviated form PUdF) in n-methyl-2-pyrroliclinone (in abbreviated form MAP).

to During the stage K3, this second slurry (prepared as a result of the stage K2) is cast into the porous (electrical current) conductive substrate. Preferably, this porous conductive substrate is a macroporous material having a pore size more than 75 microns and a porosity of about 85% (for example, from 80% to 90%). Preferably, a thickness of the porous conductive substrate consists of more than 250 microns (for example, from 250 microns to 400 microns). These selective physical parameters of the porous conductive substrate provide a more optimal coverage by the second slurry of external and internal surfaces of the porous conductive substrate during a process of second slurry casting K2 into the porous conductive substrate. The carbon fiber paper may be used as the porous conductive substrate. As an alternative of the carbon fiber paper, a carbon cloth may also be used as the porous conductive substrate. Other porous carbon-based electroconductive material having above-mentioned physical parameters and different from the carbon fiber paper (or from the carbon cloth), may also be used as the porous conductive substrate. As a result of this casting K3, the second slurry covers the external surface of the porous conductive substrate, as well as the internal surface of the porous conductive substrate. This contributes to a growth of sulfur mass-loading into the cathode according to the invention,

During the stage K4, the porous conductive substrate cast by the second slurry as a result of the stage K3, is exposed to a heat-treatment. In a first variant (not represented in FIG. 2) of the stage K4, this heat-treatment comprises only one-step carried out in a vacuum oven, for example, at 60° C., preferably, during height hours (in practice, during one night). In a second variant (represented in FIG. 2) of the stage K4—alternative of the first variant—this heat-treatment comprises two steps: a first step K41 is carried out in the vacuum oven, for example, at 60° C., preferably, during height hours (in practice, during one night), and a second step K42—following the first step K41—is carried out into an inert gaz (for example, argon) atmosphere at 300° C. during three hours. This second heat-treatment step K42 assists fixing of the to sulfur particles on the external surface of the porous conductive substrate, as well as on the internal surface of the porous conductive substrate (i.e. inside the pores). Moreover, the second heat-treatment step K42 contributes to chemical bonding of sulfur with the partially pyrolyzed at the temperature of 300° C. conductive polymer mixed with sulfur in the first variant of the stage K1. Such sulfur particles fixing contributes:

to reduce a peeling of the cathode with high (up to 4 mg/cm² as mentioned above) sulfur mass-loading from a current collector, and
to improve an electrical contact and an electrical conductivity of the second composite,

Thus, the sulfur-based cathode 3 adapted for using in the lithium metal free silicon/sulfur accumulator according to the invention is obtained as a result of the stage K4.

### EXAMPLE

As described below, an assemblage of the lithium metal free silicon/sulfur accumulator according to the invention is carried out in three phases φ₁, φ₂, φ₃, shown in FIG. 2.

A first assembling phase pi comprises all stages A1-A4 of the above-mentioned first method of manufacturing (from the first composite) of the pre-lithiated silicon-based anode 1.

In the present example, the first slurry comprises a silicon powder with particles having a diameter from 30 nm to 50 nm (for example, the silicon powder produced by Guangzhou diechuang Trading Co. Ltd).

In the present example, the stage A1 of first slurry preparing comprises a preliminary preparatory stage A10 for removing from the silicon powder particles of an (electrochemically inactive) surface film consisting of silicon oxide (in abbreviated form SiO₂). During the stage A10:

it is mixed (stage A100) 90 wt. % of the silicon powder and 10 wt. % of a conductive polymer (for example, of polyacrylonitrile produced by the Sigma-Aldrich company) dissolved in dimethylformamide DMF with a ratio “solid/DMF” equal to 1:4:
a heat-treatment of this mixture is produced (stage A101). This heat-treatment comprises three sequential steps (FIG. 2):
a first step δ is carried out in a vacuum oven, for example, at 60° C., preferably, during height hours (in practice, during one night),
a second step ν following the first step δ is carried out into an inert gaz (for example, argon) atmosphere at 300° C. during three hours,
a third step ν following the second step ν is carried out into the inert gaz (for example, argon) atmosphere at 1000° C. during five hours.

Further, it is carried out properly first slurry preparing (stage A1). For this purpose, the silicon powder (with the electrochemically inactive surface film of silicon oxide (SiO₂) removed from the silicon powder particles as a result of the preliminary preparatory stage A10) is mixed with the conductive polymer (for example, polyacrylonitrile produced by the Sigma-Aldrich company) with a mass ratio of 7:3. Further, the obtained thereby solid mixture Si/PAN is added to dimethylformamide so that the weight ratio “solid (i.e. solid mixture Si/PAN)/DMF” was equal to 1:4.

During the stage A2, the first slurry Si/PAN/DMF (resulting from the stage A1) is cast into a carbon fiber paper (i.e. into a porous conductive substrate) having a thickness of 110 micrometers (for example, the carbon fiber paper referenced <<TGP-H-030>> and produced by the Toray Industries, Inc.),

During the stage A3, the carbon fiber paper cast by the first slurry as a result of the stage A2, is exposed to a heat-treatment, which is realized in two steps: a first step A31 is carried out in the vacuum oven, for example, at 60° C., preferably, during height hours (in practice, during one night), and a second step A32—following the first step A31—is carried out into the inert gaz (for example, argon) atmosphere at 300° C. during three hours.

A silicon mass-loading into the anode obtained as a result of the stage A3, is equal to 2.5 mg/cm².

During the stage A4, a short-circuit of the silicon-based anode resulting from the stage A3 with metal lithium is carried out. This short-circuit is realized by a direct contact of the silicon-based anode resulting from the stage A3 with metal lithium in an organic electrolyte: for example, in a solution of 1 mol*dm⁻³ lithium hexafluorophosphate salt (in abbreviated form LiPF₆) in a mixture of ethylene carbonate/ethylmethyl carbonate/dimethyl carbonate (with a volume ratio 1:1:1).

Thus, the pre-lithiated silicon-based anode 1 (with the silicon mass-loading of 2.5 mg/cm²) adapted for using in the lithium metal free silicon/sulfur accumulator according to the invention is obtained as a result of the stage A4: the first assembling phase φ₁ is over.

A second assembling phase φ₂ comprises all stages K1-K4 of the above-mentioned second method of manufacturing β (from the second composite) of the sulfur-based cathode 1.

During the stage K1, it is prepared a sulfur-based third composite. In the present example, it is possible to prepare two alternative variants of the said sulfur-based third composite,

In a first variant of the stage K1, a sulfur powder (for example, a sulfur powder with a 100 mesh diameter of particles produced by the Sigma-Aldrich company) is mixed K11 with the conductive polymer, for example, with polyacrylonitrile or with polypyrrole (in abbreviated form PPy) in view to obtain a composite mixture “sulfur/conductive polymer” (for example, S/PAN or S/PPy). Further, the obtained composite mixture “sulfur/conductive polymer” is exposed to a heat-treatment K10 into an inert atmosphere, for example, at 300° C. in the argon atmosphere during three hours. The sulfur-based third composite (more precisely, a first variant of the third composite) of to “sulfur/conductive polymer” type is prepared.

In a second variant of the stage K1, which is alternative of the first variant of the stage K1, a sulfur powder (for example, a sulfur powder with a 100 mesh diameter of particles produced by the Sigma-Aldrich company) is mixed K12 with a carbon material selected, for example, from following materials: (a) granulated electroconductive carbon black (for example, produced by Akzo Nobel company under the name of <<Ketjenblack>>, in abbreviated form KB), (b) acetylene black (in abbreviated form AB), in view to obtain a composite mixture “sulfur/carbon material” (for example, S/KB or 5/AB). Further (by analogy with the first variant described above), the composite mixture “sulfur/carbon material” resulting from the stage K12, is exposed to the above-mentioned heat-treatment K10 into the inert atmosphere, for example, at 300° C. in the argon atmosphere during three hours. The sulfur-based third composite (more precisely, a second variant of the third composite) of “sulfur/carbon material” type is prepared.

During the stage K2, it is prepared a second slurry comprising:

the sulfur-based third composite resulting from the stage K1: for example, the first variant of the “sulfur/conductive polymer” third composite (S/PAN or S/PPy) or—alternatively—the second variant of the “sulfur/carbon material” third composite (S/KB or S/AB),
a carbon-based (electrical current) conductive agent, in the present example it is used an acetylene black (in abbreviated form AB), and
a binder, for example, polyvinylidene fluoride (in abbreviated form PUdF) in n-methyl-2-pyrrolidinone (in abbreviated form NMP) with a weight ratio “solid/NMP” equal to 1/1.2.

During the stage K3, this second slurry (prepared as a result of the stage K2) is cast into the carbon fiber paper, which is used in the present example as the porous (electrical current) conductive substrate. This carbon fiber paper has a thickness of 370 micrometers and is produced by the Toray Industries, Inc. under reference <<TGP-H-120>>.

During the stage K4, the carbon fiber paper cast by the second slurry as a result of the stage K3, is exposed to a heat-treatment. In a first variant (not represented in FIG. 2) of the stage K4, this heat-treatment comprises only one-step carried out in a vacuum oven, for example, at 60° C., preferably, during height hours (in practice, during one night). In a second variant (represented in FIG. 2) of the stage K4—alternative of the first variant—this heat-treatment comprises two steps: a first step K41 is carried out in the vacuum oven, for example, at 60° C., preferably, during height hours (in practice, during one night), and a second step K42—following the first step K41—is carried out into an inert gaz (for example, argon) atmosphere at 300° C. during three hours.

The cathode 3 having a sulfur mass-loading of 4 mg/cm² is obtained as a result of the stage K4. Thus, the second assembling phase φ₂ is over.

A third assembling phase φ₃ comprises three following stages C1-C3.

Firstly, a polypropylene-based separator 2 (in the present example, it is used a multilayer polypropylene separator produced by the Celgard company under reference <<2400>>) is wetted (stage C1) in an organic electrolyte. In the present example, a solution of 1 mol*dm⁻³ lithium hexafluorophosphate salt (in abbreviated form LiPF₆) in a mixture of ethylene carbonate/ethylmethyl carbonate/dimethyl carbonate with a volume ratio 1:1:1 is used as the organic electrolyte.

Further, the pre-lithiated silicone-based anode 1, the separator 2 wetted in the organic electrolyte (resulting from the stage C1) and the sulfur-based cathode 3 are piled up (stage C2) together with each other to form a stack “anode/separator/cathode” as shown in FIG. 1.

The stack “anode/separator/cathode” obtained as a result of the stage C2 (i.e. a rechargeable lithium metal free silicon/sulfur element) is put (stage C3) into a button cell or into a housing/pack for a prismatic battery.

Thus, the lithium metal free silicon/sulfur accumulator according to the invention is assembled as a result of the stage C3: the third assembling phase φ₃ is over.

1. A rechargeable battery comprising a stack consisting of an anode, a separator wetted in an organic electrolyte, and a cathode, wherein the stack is free of metal lithium, wherein the anode is pre-lithiated and comprises silicon, and wherein the cathode comprises sulfur,

2. The rechargeable battery according to claim 1, wherein the anode consists of a pre-lithiated heat-treated first composite, wherein this first composite comprises a conductive porous substrate cast by a first slurry, and wherein the first slurry is a first mixture comprising a silicon powder, a conductive polymer and dimethylformamide.

3. The rechargeable battery according to claim 2, wherein the cathode consists of a heat-treated second composite, wherein this second composite comprises the conductive porous substrate cast by a second slurry, and wherein the second slurry is a second mixture comprising a sulfur-based third composite, a carbon-based conductive agent and a binder.

4. The rechargeable battery according to claim 3, wherein the conductive polymer is selected from a following group of polymers: (a) polyacrylonitrile; (b) polypyrrole.

5. The rechargeable battery according to claim 4, wherein the sulfur-based third composite consists of a heat-treated third mixture selected from a following group of mixtures:
(a) a mixture of a sulfur powder with the conductive polymer,
(b) a mixture of a sulfur powder with a carbon material selected from a following group of materials: (i) granulated electroconductive carbon black, (j) acetylene black.

6. The rechargeable battery according to claim 5, wherein the conductive porous substrate is selected from a group of following materials: (a) carbon fiber paper; (b) carbon cloth.

7. The rechargeable battery according to claim 6, wherein the carbon-based conductive agent consists of acetylene black.

8. The rechargeable battery according to claim 7, wherein the binder consists of polyvinylidene fluoride in n-methyl-2-pyrrolidinone with a weight ratio polyvinylidene fluoride/n-methyl-2-pyrrolidinone being equal 1/1.2.

9. The rechargeable battery according to claim 7, wherein a silicon mass-loading into the pre-lithiated anode is 2.5 mg/cm², and wherein a sulfur mass-loading into the cathode is 4 mg/cm².

10. The rechargeable battery according to claim 9, wherein the silicon powder comprises particles having a diameter from 30 nm to 50 nm.

11. The rechargeable battery according to claim 10, wherein the silicon powder is free from a surface film consisting of silicon oxide.

12. The rechargeable battery according to claim 11, wherein the sulfur powder comprises particles having a 100 mesh diameter.

13. The rechargeable battery according to claim 12, wherein the organic electrolyte consists of a solution of 1 mol*dm⁻³ lithium hexafluorophosphate salt in a fourth mixture and wherein the fourth mixture consists of ethylene carbonate, ethylmethyl carbonate and dimethyl carbonate with a volume ratio 1/1/1.

14. The rechargeable battery according to claim 13, wherein the first composite comprises the conductive porous substrate consisting of the carbon fiber paper having a first thickness equal to 110 μm, and wherein the second composite comprises the conductive porous substrate from the carbon fiber paper having a second thickness equal to 370 μm.

15. Method of assembling of a rechargeable battery, the method comprising a first phase of manufacturing of an anode from a first composite, a second phase of manufacturing of a cathode from a second composite, a third phase of manufacturing of a stack consisting of the anode, a separator wetted in an organic electrolyte, and the cathode, and of putting this stack into a housing of the rechargeable battery, wherein the first phase of manufacturing of the anode from the first composite includes:
a stage of first slurry preparing by mixing a silicon powder, a conductive polymer and dimethylformamide,
a stage of first slurry casting into a porous conductive substrate for obtaining a first composite,
a stage of heat-treatment of the first composite into an inert atmosphere for obtaining a silicon-based anode,
a stage of short-circuiting of the silicon-based anode with metal lithium in an organic electrolyte for obtaining the pre-lithiated silicon-based anode.

16. Method of assembling according to claim 15, wherein the first phase of manufacturing of the anode from the first composite also includes a stage of removing of a surface film consisting of silicon oxide from particles of the silicon powder.

17. Method of assembling according to claim 16, wherein the second phase of manufacturing of a cathode from a second composite includes:
a stage of preparing of a sulfur-based third composite,
a stage of second slurry preparing by mixing the sulfur-based third composite, a carbon-based conductive agent and a binder,
a stage of second slurry casting into the porous conductive substrate for obtaining a second composite,
a stage of heat-treatment of the second composite for obtaining the sulfur-based cathode.

18. Method of assembling according to claim 17, wherein the conductive porous substrate is selected from a group of following materials: (a) carbon fiber paper; (b) carbon cloth.

19. Method of assembling according to claim 18, wherein the stage of preparing of the sulfur-based third composite includes:
a stage of mixing of a sulfur powder with the conductive polymer,
a stage of heat-treatment of the sulfur powder with the conductive polymer, and wherein the conductive polymer is selected from a following group of polymers: (a) polyacrylonitrile (b) polypyrrole.

20. Method of assembling according to claim 18, wherein the stage of preparing of the sulfur-based third composite includes:
a stage of mixing of a sulfur powder with a carbon material,
a stage of heat-treatment of the sulfur powder with the carbon material, and wherein the carbon material is selected from a following group of the carbon to materials: (a) granulated electroconductive carbon black, (b) acetylene black.
